(19) United States
(12) Patent Application Publication
(10) Pub. No.: US 2003/0155472 A1
(43) Pub. Date: Aug. 21, 2003

(54) Free-swing and self stopping rack mountable LCD monitor

(76) Inventors: Bob B. Lu, Long Beach, CA (US); Parvize A. Farzin, Irvine, CA (US)

Correspondence Address: Bob B. Lu, 473 E. 63RD St., Long Beach, CA, 90805, US

(21) Appl. No.: 10/319,902

(22) Filed: Dec. 16, 2002

Related U.S. Application Data
(60) Provisional application No. 60/357,109, filed on Feb. 19, 2002.

(51) Int. Cl. F16M 11/00

(52) U.S. Cl. 248/201; 248/917

(57) ABSTRACT

A special designed LCD monitor along with its free-swing and self-stopping pivot mechanism has been invented. The invention allows the LCD monitor to be mounted on a 19″ EIA standard rack with adjustable viewing angle either vertically or horizontally. The scope of the protection of the patent is consisted of two parts: the way to construct a rack mountable LCD monitor and the way to adjust the viewing angle by using the invented free-swing but self-stopping pivot mechanism.

### CROSS REFERENCE TO RELATED APPLICATIONS

Not Applicable. Statement Regarding Federally Sponsored Research or Development:

Not Applicable.

### BACKGROUND OF THE INVENTION

The background behind this invention is due to the fact that LCD monitors have only limited viewing angles, both in horizontal and in vertical.

The LCD monitors need to be viewed at eye level to get the best picture quality. A desk top LCD monitor usually has a swivel base, so that the viewing angle of the screen can be adjusted to the viewer's desire.

However, a rack mount LCD monitor does not have the viewing angle flexibility, although it can save a lot of desk space. If a rack mount LCD monitor is attached on the upper portion of an EIA standard 19″ rack, then the picture or image on the monitor screen may not be seen as clear as that when the monitor sits on the eye level. The worst case is the picture may look like totally black or very dark if the monitor is mounted too high from the desk of a viewer, in most case, of a security officer.

As a result of the inconvenience to the viewer, the need has arisen for a rack mountable LCD monitor that not only can be attached on a 19″ EIA standard rack to save the desk space, but also its viewing angle can be adjusted so as to make the picture on the monitor screen can be seen as good as when it is on the eye level.

The technical field of this invention may be categorized either into LCD monitor or rack mountable LCD monitor.

### BRIEF SUMMARY OF THE INVENTION

A special designed LCD monitor along with its free-swing and self-stopping pivot mechanism has been invented. The invention allows the LCD monitor to be mounted on a 19″ EIA standard rack with adjustable viewing angle either vertically or horizontally. The patent is consisted of two parts: the way to build a rack mountable LCD monitor and the way to adjust the viewing angle, free-swing but self-stopping.

### BRIEF DESCRIPTION OF THE SEVERAL VIEWS OF THE DRAWING

FIG. 1 is the explosive view and the assembly relationship between the housing of LCD monitor and its vertically free-swing and self-stopping pivot.

FIG. 2 is the front view of FIG. 1

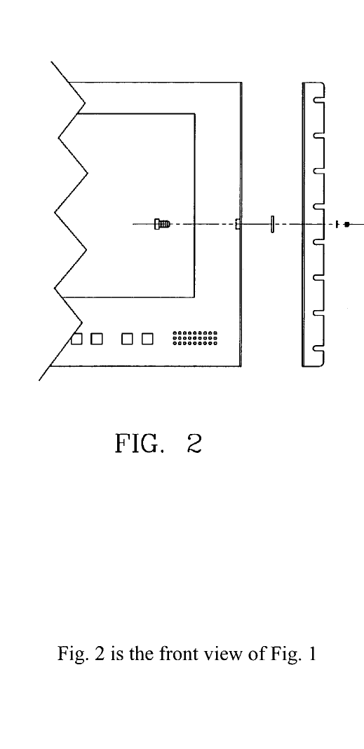

FIG. 3 is the top view of FIG. 1

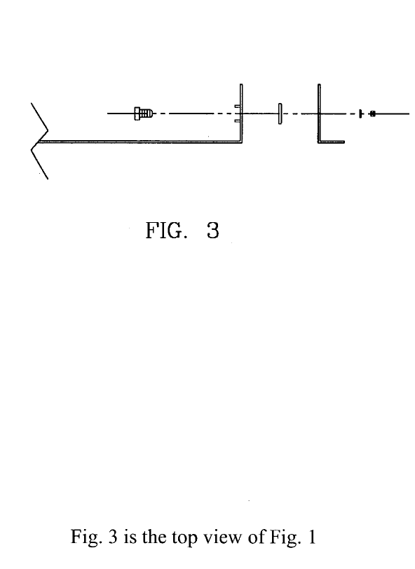

FIG. 4 is an isometric view of the completely assembled rack mountable LCD monitor and how it is tilted on the 19″ EIA standard rack.

FIG. 5 is the explosive view for the pan version.

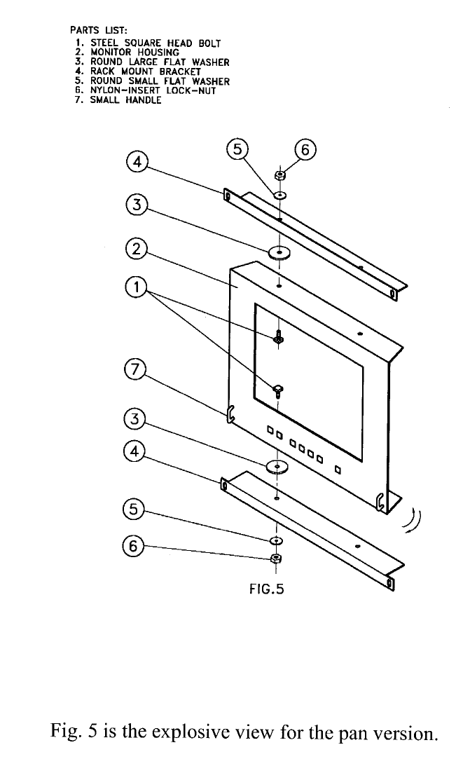

FIG. 6 shows how the LCD monitor is left-panned on the 19″ rack.

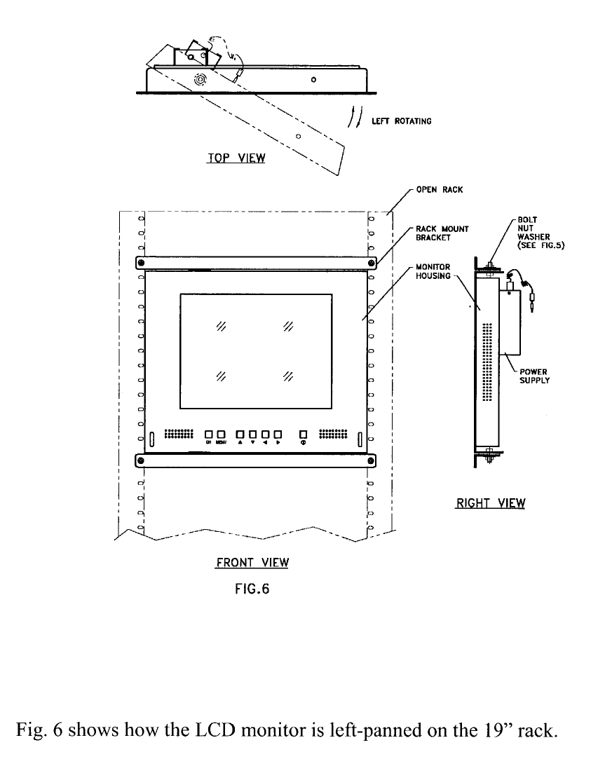

FIG. 7 shows how the LCD monitor is right-panned on the 19″ rack.

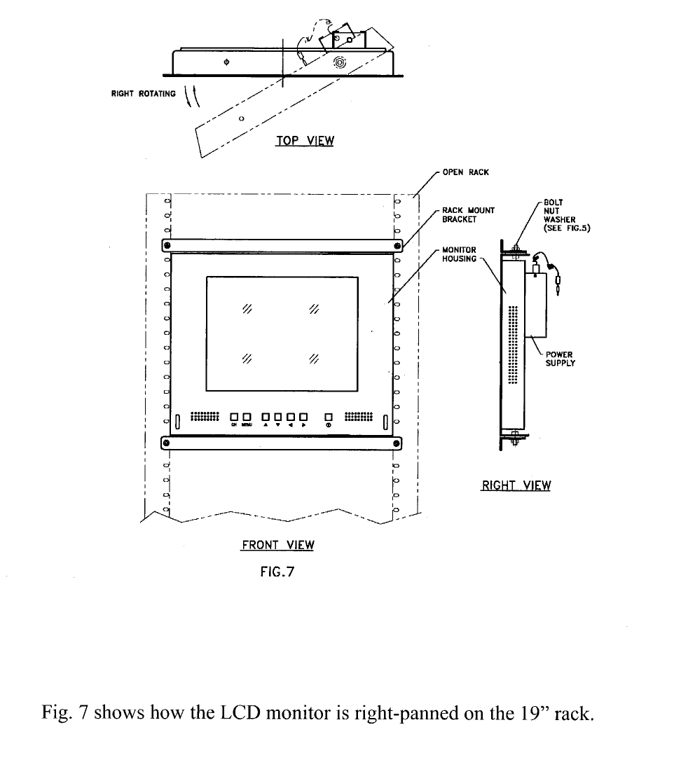

### DETAILED DESCRIPTION OF THE INVENTION

According to the invention, the Free-Swing and Self-Stopping Rack Mountable LCD Monitor is constructed for mounting the LCD monitor onto an EIA Standard 19″ rack or rack cabinet and making the monitor to be not only freely tilted or panned but also self-stopped at any desired position.

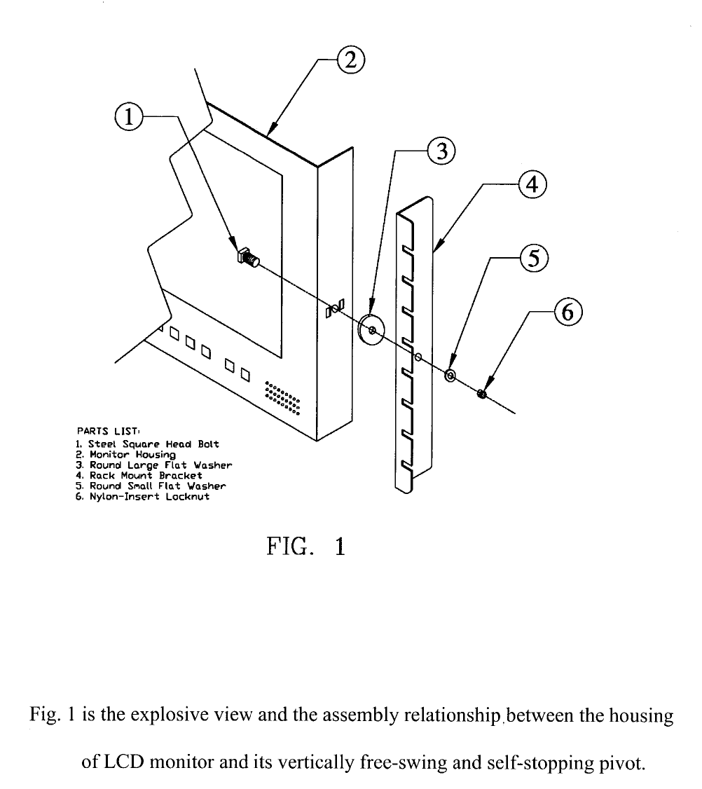

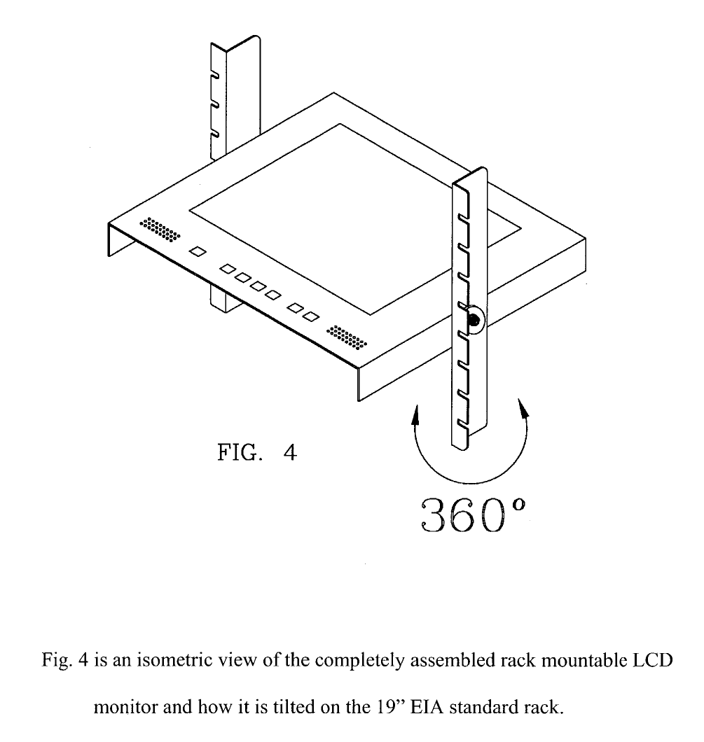

The invented mechanism is consists of six parts: steel bolt (1), monitor housing (2), large washer (3), rack mount bracket (4), small washer (5) and nut (6). The process of making or assembling this monitor is very simple, straight forward, and is self-explained in FIG. 1 for the tilt version and FIG. 4 for the pan version. After the square head bolt is inserted into the opening of the monitor housing where it passes through a large round flat Teflon washer, the bolt is penetrated the rack mount bracket where a small round flat washer and a nylon inserted locknut are used to fasten the whole assembly together.

In accordance with the present invention, the Teflon washer, or its substitute with similar materials, acts like a bearing at each end of the monitor housing, which enables the monitor housing to be rotated freely at its axis. At the same time, by means of the compressibility and the adhesiveness, the Teflon washer also acts as a brake pad to stop the rotating at any desired position.

1. We claim that the scope of the protection of our invention is the way to construct, build, assemble, and/or to produce the rack mountable LCD monitor which uses the free-swing and self-stopping pivot mechanism specified by this invention to adjust the viewing angle of the monitor on a 19″ EIA standard open rack or rack cabinet.
